(19) United States
(12) Patent Application Publication
(10) Pub. No.: US 2023/0063079 A1
(43) Pub. Date: Mar. 2, 2023

(54) SPECULATIVE RESOLUTION OF LAST BRANCH-ON-COUNT AT FETCH

(71) Applicant: International Business Machines Corporation, Armonk, NY (US)

(72) Inventors: Mehul Patel, Austin, TX (US); Nicholas R. Orzol, Austin, TX (US); Dung Q. Nguyen, Austin, TX (US); Balaram Sinharoy, LAGRANGEVILLE, NY (US); Richard J. Eickemeyer, Rochester, MN (US); John B. Griswell, Jr., Austin, TX (US); Brian W. Thompto, Austin, TX (US)

(21) Appl. No.: 17/410,223

(22) Filed: Aug. 24, 2021

(51) Int. Cl. G06F 9/38; G06F 9/30

(52) U.S. Cl. CPC G06F 9/3867; G06F 9/3802; G06F 9/3861; G06F 9/30065

(57) ABSTRACT

A computer processor includes an instruction pipeline configured to dispatch a plurality of branch-to-count (BCNT) instructions and an instruction fetch unit (IFU). The IFU is configured to execute an instruction loop for fetching a targeted number of BCNT instructions from the instruction pipeline and to monitor a loop counter that counts a number of fetched BCNT instructions that are actually fetched from the instruction pipeline in response to executing the instruction loop. The IFU resolves a final BCNT instruction included in the instruction loop in response to the number of fetched BCNT instructions reaching a target loop count value.

### BACKGROUND

The present invention generally relates to computer systems, and more specifically, to programmed instruction processing in a microprocessor.

A pipeline microprocessor has a path, channel, or pipeline that is divided into stages that perform specific tasks. Each of the specific tasks are part of an overall operation that is directed by a programmed instruction. As a programmed instruction enters the first stage of the pipeline, certain tasks are accomplished. The instruction is then passed to subsequent stages for accomplishment of subsequent tasks. Following completion of a final task, the instruction completes execution and exits the pipeline. Execution of programmed instructions by a pipeline microprocessor is very much analogous to the manufacture of items on an assembly line.

One of the obvious aspects of any assembly line is that there are multiple items resident in the line in successive stages of assembly during any given point in time. The same is true for a pipeline microprocessor. During any cycle of a pipeline clock signal, multiple instructions can be present in the various stages, with each of the instructions being at successive levels of completion. Therefore, microprocessors allow overlapping execution of multiple instructions with the same circuitry. The circuitry is usually divided up into stages and each stage processes a specific part of one instruction at a time, passing the partial results to the next stage.

### SUMMARY

According to another non-limiting embodiment, a computer processor includes an instruction pipeline configured to dispatch a plurality of branch-to-count (BCNT) instructions and an instruction fetch unit (IFU). The IFU is configured to execute an instruction loop for fetching a targeted number of BCNT instructions from the instruction pipeline and to monitor a loop counter that counts a number of fetched BCNT instructions that are actually fetched from the instruction pipeline in response to executing the instruction loop. The IFU resolves a final BCNT instruction included in the instruction loop in response to the number of fetched BCNT instructions reaching a target loop count value.

According to a non-limiting embodiment, a computer implemented method comprises dispatching, via an instruction pipeline, a plurality of branch-to-count (BCNT) instructions; and executing, via an instruction fetch unit (IFU), an instruction loop for fetching a targeted number of BCNT instructions from the instruction pipeline. The method further comprises monitoring, via the IFU, a loop counter that counts a number of fetched BCNT instructions that are actually fetched from the instruction pipeline in response to executing the instruction loop; and resolving, via the IFU, a final BCNT instruction included in the instruction loop in response to the number of fetched BCNT instructions reaching a target loop count value.

According to yet another non-limiting embodiment, a computer program product comprising a computer readable storage medium having program instructions embodied therewith. The program instructions are executable by one or more processors to cause the one or more processors to perform operations comprising dispatching, via an instruction pipeline, a plurality of branch-to-count (BCNT) instructions; and executing, via an instruction fetch unit (IFU), an instruction loop for fetching a targeted number of BCNT instructions from the instruction pipeline. The method further comprises monitoring, via the IFU, a loop counter that counts a number of fetched BCNT instructions that are actually fetched from the instruction pipeline in response to executing the instruction loop; and resolving, via the IFU, a final BCNT instruction included in the instruction loop in response to the number of fetched BCNT instructions reaching a target loop count value.

Other embodiments of the present invention implement features of the above-described method in computer systems and computer program products. Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of a processor included in a computing system according to a non-limiting embodiment of the present disclosure;

FIG. 3 depicts a block diagram of a latch stage included in the processor illustrated in FIG. 2 according to a non-limiting embodiment of the present disclosure; and

FIG. 4 depicts a block diagram of a branch-on-count (BCNT) prediction stage included in the processor illustrated in FIG. 2 according to a non-limiting embodiment of the present disclosure.

### DETAILED DESCRIPTION

In related technologies, Branch instructions (also simply referred to as a “Branch”) are used in computer processor architecture and design to control the program counter (PC). The program counter stores the memory address of the next instruction to be executed. Therefore, a Branch can cause the processor to begin fetching its instructions from a different sequence of memory cells. Branch-on-Count instructions (also simply referred to as a “BCNT”) are used to control the behavior of a Branch resolution in response to performing an instruction loop. When executing an instruction loop, a BCNT instruction can subtract a “1” value from the value of the contents of a target register. If the value in the target register after the subtraction does not meet a target value (e.g., a “0” value), no branch occurs and the code associated with the instruction loop is re-executed. Otherwise, the Branch is resolved and the program exits the loop and branches to the address contained in the branch register.

Conventional processor architectures require that a BCNT included in an instruction loop is resolved when it gets executed (e.g., by a vector scalar unit (VSU)). Therefore, the processor may experience latency while waiting for VSU to execute the BCNT instruction before the Branch can be resolved. To solve this problem, some architectures have attempted to predict when the final BCNT included in the instruction loop will be fetched from the pipeline. However, it is common for the final BCNT of the loop to be predicted incorrectly. The misprediction can cause an incorrect instruction to be fetched, which must be subsequently flushed. Consequently, the misprediction of the branch count can cause a performance penalty due to flushing of the mispredicted branch path.

In accordance with one or more embodiments of the present disclosure, a processor is provided that is configured to count and keep track of how many BCNTs are being fetched versus the number of BCNTs that the instruction loop is targeted to fetch. The processor is capable performing early-detection of a loop-exiting branch instruction to speculate resolution of a last branch-on-count instruction at the time of fetch. The processor can capture address information and leverage the instruction effective address table to identify a plurality of move-to-count-register instructions. Decrementing-branch instructions are counted by the processor as they are fetched, and when a branch count matches a count register value the branch instruction is resolved early. The early resolution of the branch allows the processor to predict a branch misprediction earlier than conventional processors. Accordingly, the processor can broadcast a flush request sooner to avoid further execution on the wrong branch path.

According to a non-limiting embodiment, the processor includes a BCNT prediction stage that employs a BCNT monitoring unit following the instruction pipeline. The BCNT monitoring unit includes one or more registers (collectively referred to herein as a “shadow register”, which captures address information and leverages the instruction effective address table to identify a plurality of move-to-count-register instructions. The BCNT monitoring unit is configured to correlate the move-to-count register instructions with fetched BCNTs. The BCNT monitoring unit decrements a loop counter to track the actual number of BCNTs that are fetched. In other words, the BCNT monitoring unit counts decrementing-branch instructions as being fetched. When the loop counter reaches zero, the last BCNT can be resolved early in the pipeline without waiting for the VSU to execute the Branch. Accordingly, early flushing and re-direct of a mis-predicted branch path increases the speed and performance of the processor.

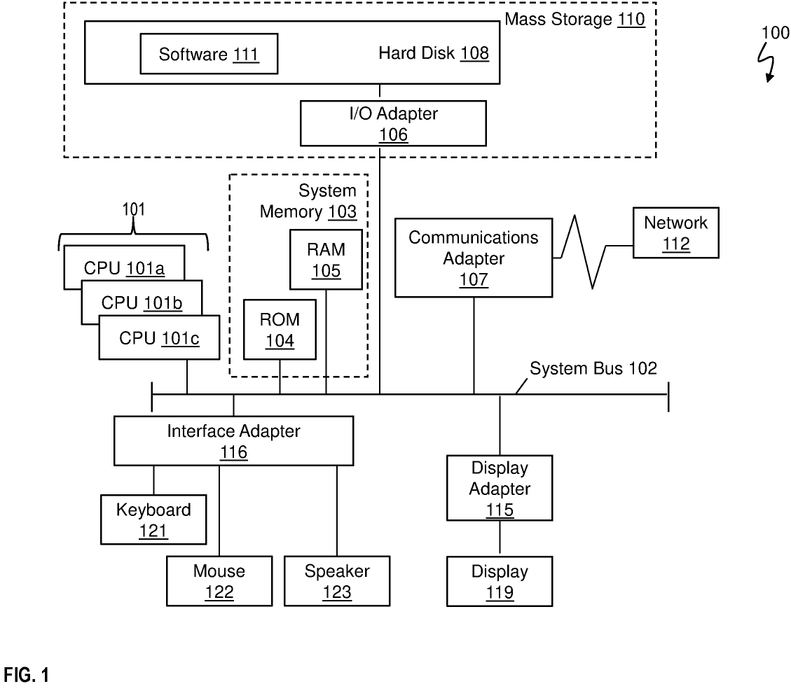

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, and storage capability including the system memory 103 and the mass storage 110, input means such as the keyboard 121 and the mouse 122, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

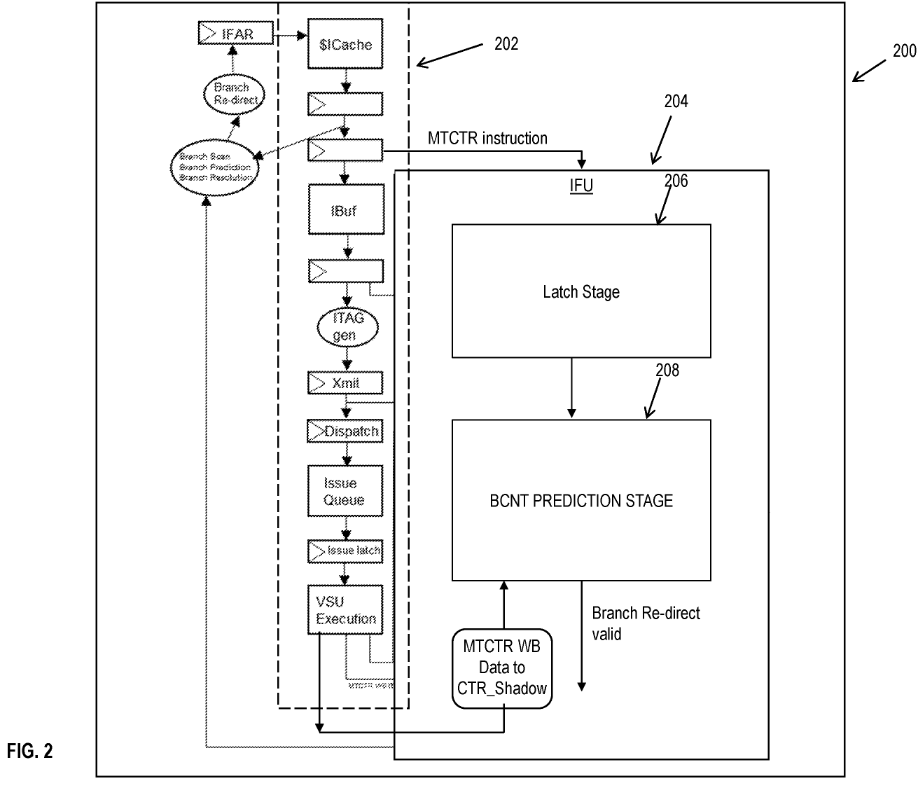

Turning now to FIG. 2, an example of a hardware computer processor 200 is illustrated according to one or more embodiments of the inventions. The processor 200 can be representative of any of the processors 101 discussed in computer system 100 in FIG. 1. The processor 200 employs an example of a high-level architecture of an instruction pipeline 202 configured to facilitate an instruction flow through various stages. The pipeline stages can include, but are not limited to, an instruction fetch stage, an instruction dispatch stage, an instruction decode/issue stage, an execute stage, a commit stage, and a writeback stage. It should be appreciated that the example processor 200 illustrated in FIG. 2 is not intended to include every detail of an instruction pipeline, and can include fewer or more modules, blocks and/or stages as understood by one of ordinary skill in the art.

The various components, modules, stages, engines, etc., described in the pipeline 202 can be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these. In examples, the modules described herein can be a combination of hardware and programming. The programming can be processor executable instructions stored on a tangible memory, and the hardware can include processing circuitry for executing those instructions. Alternatively or additionally, the modules can include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. Further, the modules can include various logic circuits to function as discussed herein.

With continued reference to FIG. 2, the processor 200 further employs an instruction fetch unit (IFU) 204 configured to fetch and receive instructions provided by the pipeline 202. The IFU 204 includes a latch stage 206 and a branch-on-count (BCNT) prediction stage 208. The IFU 204 utilizes the latch stage to identify a plurality of move-to-count (MTCTR) register instructions delivered into the pipeline 202.

The BCNT prediction stage 208 also monitors the pipeline 202 to detect MTCTR register instructions. When a MTCTR register instruction is read out from the pipeline 208, the BCNT prediction stage 208 associates a BCNT instruction with the obtained MTCTR register instruction. Further, the BCNT prediction stage is informed with a number of BCNT instructions that are going to be fetched. Accordingly, the BCNT prediction stage 208 can count and track the number of BCNT instructions that are generated versus the number of BCNT instructions that are going to be fetched. When the BCNT count reaches zero, then the last BCNT instruction can be resolved early in the pipeline 202 without waiting for the VSU to execute the Branch. According to a non-limiting embodiment, the BCNT prediction stage decrements the BCNT count as BCNT instructions are generated and fetched. When the branch count matches a targeted count register value (e.g., 0), the branch instruction is resolved early such that on a misprediction, a flush is broadcast sooner to avoid further execution on the wrong branch path, thereby increasing the performance of the processor and computer system.

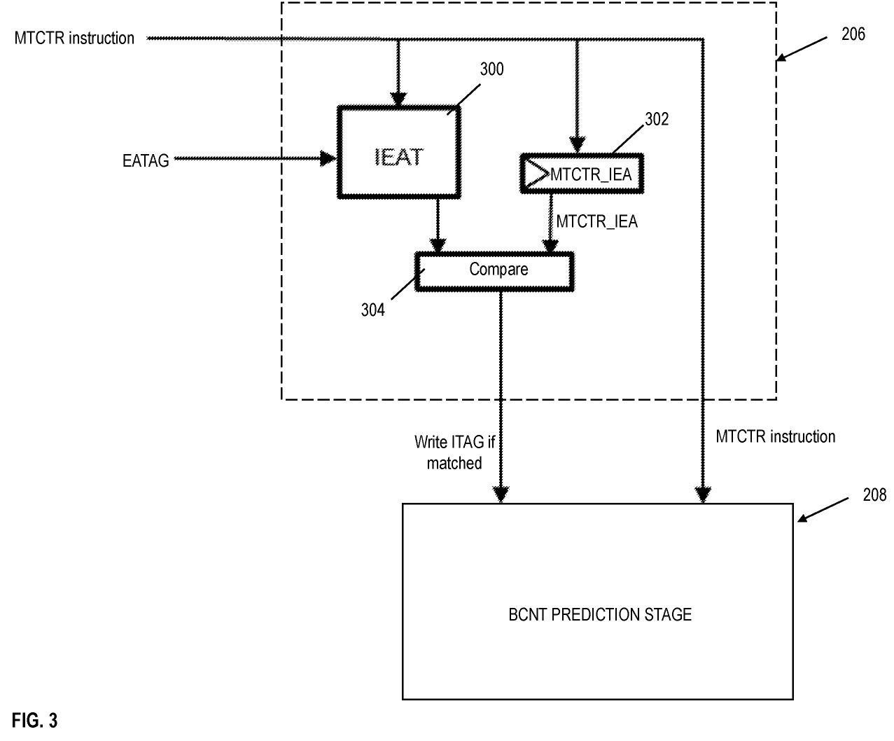

Referring to FIG. 3, the latch stage 206 is illustrated according to a non-limiting embodiment. The latch stage 206 includes an instruction effective address table (IEAT) 300, a MTCTR_IEA unit 302 and a compare unit 304. The IEAT 300 is configured to capture address information that identifies a plurality of move-to-count (MTCTR) register instructions delivered into the pipeline 202. According to a non-limiting embodiment, the IFU 204 provides an effective address tag (EATAG) to the latch stage 206. The IEAT 300 associates an EATAG with a longer effective address (EA) for each instruction, because referring to each instruction by its full effective address throughout the processor design results in an imposing and unnecessary complexity.

The compare unit 304 compares a given IEA from the IEAT 300 with a MTCTR instruction effective address (MTCTR_IEA) associated with a given MTCTR register instruction. When the IEA from the IEAT 300 matches the MTCTR_IEA, the compare unit 304 outputs a corresponding ITAG to the BCNT prediction stage 208. In other words if the IEAT 300 matches the MTCTR_IEA, the compare unit 304 outputs a control signal that commands the corresponding MTCTR_ITAG register to store the MTCTR_ITAG (e.g., “ITAG”) provided by the pipeline 202. In this manner, the BCNT prediction stage 208 can utilize the MTCTR_ITAG to keep track of the number of fetched BCNT instructions as described in greater detail below.

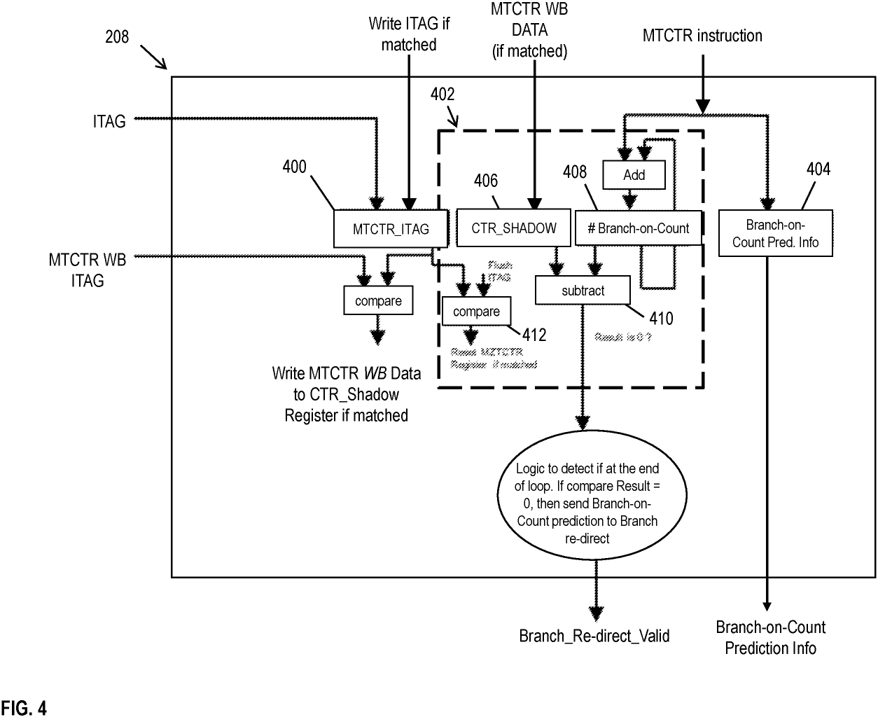

With reference to FIG. 4, the BCNT prediction stage 208 is illustrated according to a non-limiting embodiment. The BCNT prediction stage 208 includes a MTCTR_ITAG register 400, a BCNT monitoring unit 402, and a BCNT prediction register 404. The MTCTR_ITAG register 400 is configured to store the ITAG corresponding to the MTCTR instruction that is associated with the matched ITAG output from the compare unit 304.

The BCNT monitoring unit 402 includes a shadow register 406, a branch-on-count unit 408, a count decrementing unit 410, and a reset compare unit 412. The shadow register 406 is configured to receive write back (WB) data corresponding to a given executed MTCTR instruction (e.g., a MTCTR instruction executed by the VSU), and utilize this MTCTR WB data to keep track of a fetched BCNT instruction. The BCNT prediction register 404 is configured to receive the MTCTR instruction from the pipeline 202. The branch-on-count unit 408 is also configured to receive the MTCTR instruction from the pipeline 202, but includes a feedback loop that increments a BCNT count each time a MTCTR instruction is received. Accordingly, the branch-on-count unit 408 can operate as a loop counter that increments a loop count value in response to receiving a MTCTR instruction. The current total of the BCNT count stored in the branch-on-count unit 408 is then output to the count decrementing unit 410, which subtracts the MTCTR WB data from the total BCNT count.

When the count of the decrementing unit 410 reaches 0 (i.e., when the last BCNT of the loop is sent from the instruction cache (ICache) in the pipeline 202), then the BCNT monitoring unit 402 outputs a Branch re-direction signal (Branch_Re-direct_Valid) that can be utilized to initiate a fetch operation to obtain the correct Branch path.

In one or more non-limiting embodiments, the Branch re-direction signal (Branch_Re-direct_Valid) can be used together with the received MTCTR instruction to properly redirect a branch. For example, the decrementing unit 410 is capable of reaching 0 before the instruction loop is exited. Accordingly, the BCNT prediction register 404 can output its currently stored MTCTR instruction. The MTCTR instruction can be utilized as “Branch-on-Count prediction information”, which can then be used to fetch the correct Branch path before the instruction loop is exited and/or VSU executes the Branch path. Accordingly, the Branch re-direction signal can be utilized to indicate a “valid” field while the Branch-on-Count prediction information provided by the MTCTR instruction can be utilized as a second field that provides the branch information package.

With continued reference to FIGS. 2, 3 and 4, an example the system’s capability to perform a speculative resolution of a last branch-on-count (BCNT) instruction at fetch is described according to non-limiting embodiments of the present disclosure. As described herein, after performing a fetch from the ICache included in the pipeline 202, the IFU 204 utilizes the latch stage 206 to hold information such as ITAG and Instruction Effective Address (IEA) of the MTCTR instruction. The IFU also utilizes the BCNT monitoring unit 402 included in the BCNT prediction stage 208 to perform a BCNT loop count, count a number of Branch-on-count instructions read out from the instruction buffer (IBuf) included in the pipeline 202, and predict information of the BCNT instruction.

The IBuf of the pipeline 202 is configured to store the MTCTR instruction, the BCNT instruction, and the index into the IEAT (i.e., EATAG). Each time a MTCTR instruction is read out of the ICache included in the pipeline 202, its information is written into the MTCTR_IEA unit 302 included in the latch stage 206. For example, the IFU 204 monitors the pipeline 202 to determine whether a MTCTR instruction is output from the ICache. If there is a MTCTR present in the pipeline 202, then the IFU 204 writes its IEA into the MTCTR_IEA unit 302. The IEA obtained from the pipeline 202 is also written into the IEAT 300, and the loop count value corresponding to the branch-on-count unit 408 is reset to 0.

The IFU 204 further determines if a BCNT instruction is output from the ICache. If a BCNT instruction is present in the pipeline 202, then the IFU 204 increments the loop count value of the branch-on-count unit 408. The information of the detected BCNT instruction is also delivered to the BCNT prediction register 404 and is stored therein.

When the MTCTR instruction is read out of the IBuf and assigned an ITAG, its EATAG is used by the latch stage 206 to read the IEAT to output the corresponding IEA to the compare unit 304. The compare unit 304 compares the IEA with the MTCTR_IEA obtained from the MTCTR_IEA unit 302. When the IEA matches the MTCTR_IEA, the MTCTR_ITAG output from the IBuf is delivered to the BCNT prediction stage 208 and stored in the MTCTR_ITAG register 400.

The MTCTR output from the IBuf is delivered to the Issue Queue included in the pipeline 202 and is scheduled for execution by the VSU. Accordingly, the VSU will execute the MTCTR instruction and write back the result into the main register file and the shadow register (see e.g. ,FIG. 2). Accordingly, at write back time, the VSU will send the MTCTR WB ITAG along with the MTCTR data to write into the shadow register 406. According to a non-limiting embodiment, the MTCTR WB ITAG is compared to all MTCTR_ITAGs (e.g., included in a FIFO queue). If matched, the MTCTR instruction associated with the MTCTR WB ITAG is confirmed to be the MTCTR instruction intended to be tracked, and the corresponding MTCTR WB data is written into the shadow register 406.

If the loop count value is unavailable when a BCNT instruction is read out of the ICache, the IFU 204 will continue to track and count the number of BCNT instructions being read out of the IFU 204. When the MTCTR instruction is executed by the VSU, the MTCTR WB data is written into the shadow register 406. Accordingly, the IFU 204 subtracts the MTCTR WB data stored in the shadow register 406 from the total number of counted BCNT instructions stored in the branch-on-count unit 408. If the subtracted result is 0 (i.e., when the last BCNT instruction of the loop is sent from the ICache), then its BCNT predicted data will be sent to the Branch Resolution to resolve the BCNT instruction and cause a Branch re-direct early without waiting for the BCNT instruction to execute.

According to a non-limiting embodiment, if the loop count value is available when a BCNT is read out of the ICache, the BCNT instruction delivered from the ICache will be accumulated into the branch-on-count unit 408. Accordingly, the data stored in the shadow register 406 is subtracted from the number of accumulated BCNT instructions stored in the branch-on-count unit 408. If the subtracted result is 0 (i.e., when the last BCNT instruction of the loop is sent from the ICache), then its associated BCNT prediction information is sent to the Branch Resolution to resolve the BCNT early and cause a Branch re-direct without waiting for the BCNT instruction to execute. When the currently tracked BCNT instruction is determined to be correctly predicted, the BCNT prediction stage 208 will not generate a Branch-redirect. When, however, the currently tracked BCNT instruction is determined to be mispredicted, then a Branch re-direct will be generated by the BCNT prediction stage 208 to fetch the correct Branch path. Accordingly, early flushing and re-direct of a mis-predicted branch path can be achieved, thereby realizing an increase in the performance of the processor 200.

As described herein, various non-limiting embodiments of the present disclosure provide a processor that is configured to count and keep track of how many BCNTs are being fetched versus the number of BCNTs that the loop is targeted to fetch. In one or more non-limiting embodiments, the processor includes a BCNT prediction stage that employs a shadow register capable of decrementing a loop counter to track the actual number of BCNT’s that are fetched. When the loop counter reaches zero, then the last BCNT can be resolved early in the pipeline without waiting for the VSU to execute the branch so as to perform early flushing and re-direct of a mispredicted branch path.

Various embodiments of the present disclosure are described with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer processor comprising:
an instruction pipeline configured to dispatch a plurality of branch-to-count (BCNT) instructions; and
an instruction fetch unit (IFU) configured to execute an instruction loop for fetching a targeted number of BCNT instructions from the instruction pipeline, and to monitor a loop counter that counts a number of fetched BCNT instructions that are actually fetched from the instruction pipeline in response to executing the instruction loop,
wherein the IFU resolves a final BCNT instruction included in the instruction loop in response to the number of fetched BCNT instructions reaching a target loop count value,
wherein the IFU resolves a final BCNT instruction by confirming the given BCNT instruction included in the instruction loop is the final BCNT instruction or confirming the given BCNT instruction included in the instruction is mispredicted as the final BCNT instruction, and,
wherein the computer processor confirms the prediction or the misprediction of the final BCNT instruction prior to exiting the instruction loop, and in response to confirming the misprediction resolves the BCNT without waiting for the BCNT instruction to execute.

2. (canceled)

3. (canceled)

4. The computer processor of claim 1, wherein the IFU comprises:
a latch stage configured to monitor the instruction pipeline and identify a plurality of move-to-count register (MTCTR) instructions; and
a BCNT prediction stage configured to monitor the instruction pipeline and associates a fetched BCNT instruction with a given MTCTR register instruction fetched from the pipeline,
wherein the MTCT instructions are utilized to track the fetched BCNT instruction.

5. The computer processor of claim 4, wherein the BCNT prediction stage adjusts the loop counter in response to detecting the given BCNT instruction fetched from the pipeline.

6. The computer processor of claim 5, wherein the BCNT prediction stage comprises:
the loop counter configured to increment a loop count value in response to detection of the given BCNT instruction fetched from the pipeline; and
a shadow register configured to receive MTCTR write back data in response to the given MTCTR register instruction executed from the pipeline.

7. The computer processor of claim 6, wherein the BCNT prediction stage decrements the loop count value in response to storing the MTCTR write back data, and predicts the final BCNT instruction included in the instruction pipeline in response to the loop count value reaching the target loop count value.

8. A computer implemented method comprising:
dispatching, via an instruction pipeline, a plurality of branch-to-count (BCNT) instructions;
executing, via an instruction fetch unit (IFU), an instruction loop for fetching a targeted number of BCNT instructions from the instruction pipeline;
monitoring, via the IFU, a loop counter that counts a number of fetched BCNT instructions that are actually fetched from the instruction pipeline in response to executing the instruction loop; and
resolving, via the IFU, a final BCNT instruction included in the instruction loop in response to the number of fetched BCNT instructions reaching a target loop count value, wherein the resolving includes resolving a final BCNT instruction by confirming the given BCNT instruction included in the instruction loop is the final BCNT instruction or confirming the given BCNT instruction included in the instruction is mispredicted as the final BCNT instruction;
confirms, by the computer processor, the prediction or the misprediction of the final BCNT instruction prior to exiting the instruction loop; and
in response to confirming the misprediction, resolving the BCNT without waiting for the BCNT instruction to execute.

9. The method of claim 8, further comprising resolving, via the IFU, a final BCNT instruction by confirming the given BCNT instruction included in the instruction loop is the final BCNT instruction or confirming the given BCNT instruction included in the instruction is mispredicted as the final BCNT instruction.

10. The method of claim 9, further comprising confirming, via the compute processor, the prediction or the misprediction of the final BCNT instruction prior to exiting the instruction loop.

11. The method of claim 10, further comprising:
monitoring, via a latch stage included in the IFU, the instruction pipeline;
identifying, via the latch state, a plurality of move-to-count register (MTCTR) instructions; and
monitoring, via a BCNT prediction stage included in the IFU; and
associating, via the BCNT prediction stage, a fetched BCNT instruction with a given MTCTR register instruction fetched from the pipeline.

12. The method of claim 11, further comprising adjusting, via the BCNT prediction stage, the loop counter in response to detecting the given BCNT instruction fetched from the pipeline.

13. The method of claim 12, further comprising:
incrementing a loop count value of the loop counter in response to detection of the given BCNT instruction fetched from the pipeline; and
receiving, via a shadow register included in the BCNT prediction stage, MTCTR write back data in response to the given MTCTR register instruction executed from the pipeline.

14. The method of claim 13, further comprising decrementing the loop count value in response to storing the MTCTR write back data, and predicts the final BCNT instruction included in the instruction pipeline in response to the loop count value reaching the loop count value.

15. A computer program product comprising a computer readable storage medium having program instructions embodied therewith, the program instructions executable by one or more processors to cause the one or more processors to perform operations comprising:
dispatching, via an instruction pipeline, a plurality of branch-to-count (BCNT) instructions;
executing, via an instruction fetch unit (IFU), an instruction loop for fetching a targeted number of BCNT instructions from the instruction pipeline;
monitoring, via the IFU, a loop counter that counts a number of fetched BCNT instructions that are actually fetched from the instruction pipeline in response to executing the instruction loop; and
resolving, via the IFU, a final BCNT instruction included in the instruction loop in response to the number of fetched BCNT instructions reaching a target loop count value, wherein the resolving includes resolving a final BCNT instruction by confirming the given BCNT instruction included in the instruction loop is the final BCNT instruction or confirming the given BCNT instruction included in the instruction is mispredicted as the final BCNT instruction;
confirms, by the computer processor, the prediction or the misprediction of the final BCNT instruction prior to exiting the instruction loop; and
in response to confirming the misprediction, resolving the BCNT without waiting for the BCNT instruction to execute.

16. The computer program product of claim 15, wherein the operations further comprise resolving, via the IFU, a final BCNT instruction by confirming the given BCNT instruction included in the instruction loop is the final BCNT instruction or confirming the given BCNT instruction included in the instruction is mispredicted as the final BCNT instruction.

17. The computer program product of claim 16, wherein the operations further comprise confirming, via the compute processor, the prediction or the misprediction of the final BCNT instruction prior to exiting the instruction loop.

18. The computer program product of claim 17, wherein the operations further comprise:
monitoring, via a latch stage included in the IFU, the instruction pipeline;
identifying, via the latch state, a plurality of move-to-count register (MTCTR) instructions; and
monitoring, via a BCNT prediction stage included in the IFU; and
associating, via the BCNT prediction stage, a fetched BCNT instruction with a given MTCTR register instruction fetched from the pipeline.

19. The computer program product of claim 18, wherein the operations further comprise adjusting, via the BCNT prediction stage, the loop counter in response to detecting the given BCNT instruction fetched from the pipeline.

20. The computer program product of claim 19, wherein the operations further comprise:
incrementing a loop count value of the loop counter in response to detection of the given BCNT instruction fetched from the pipeline;
receiving, via a shadow register included in the BCNT prediction stage, MTCTR write back data in response to the given MTCTR register instruction executed from the pipeline; and
decrementing the loop count value in response to storing the MTCTR write back data, and predicts the final BCNT instruction included in the instruction pipeline in response to the loop count value reaching the loop count value.

21. The computer processor of claim 1, wherein resolving the BCNT without waiting for the BCNT instruction to execute includes causing a branch re-direct without waiting for the BCNT instruction to execute.

22. The method of claim 8, wherein resolving the BCNT without waiting for the BCNT instruction to execute includes causing a branch re-direct without waiting for the BCNT instruction to execute.

23. The A computer program product of claim 22, wherein resolving the BCNT without waiting for the BCNT instruction to execute includes causing a branch re-direct without waiting for the BCNT instruction to execute.
